(19) United States
(12) Patent Application Publication
(10) Pub. No.: US 2005/0258230 A1
(43) Pub. Date: Nov. 24, 2005

(54) Processing passengers, baggage and cargo

(76) Inventor: Keith Wiater, Ft. Lauderdale, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(21) Appl. No.: 11/130,875

(22) Filed: May 17, 2005

Related U.S. Application Data
(60) Provisional application No. 60/572,003, filed on May 18, 2004.

(51) Int. Cl. G06F 17/00

(52) U.S. Cl. 235/375; 340/572.1; 340/5.1; 705/28

(57) ABSTRACT

The invention relates to a system and method for processing passengers and baggage. A passenger traveling from a hotel or convention center to a destination via a commercial flight uses a passenger and baggage processing computer system. After the appropriate identification information is inputted into the computer system, baggage identification tags, a baggage claim receipt, and at least one boarding pass are printed. An authorized agent collects the tagged baggage from the hotel or convention center and transports it to a screening facility where the baggage is screened. Once screened and deemed safe, the baggage is then transported to a location designated by the airline (e.g., airplane, airport baggage sorting/handling system).

### CROSS REFERENCE TO RELATED APPLICATION

The present application claims the priority of U.S. provisional patent application Ser. No. 60/572,003 filed May 18, 2004.

### FIELD OF THE INVENTION

The invention relates to systems, methods, and facilities for processing passengers, baggage and cargo through an airport or other transportation facility.

### BACKGROUND

Baggage can impose a number of physical constraints and inconveniences on a traveler. For example, after checking out of a hotel, a traveler is burdened with storing or carrying baggage until checking in at the airport. Check-out times for hotels are typically early in the day (e.g., 11:00am-1:00pm) and in the case of a traveler whose flight is not scheduled until several hours later, the traveler may want to spend those available hours further sight-seeing or visiting. This traveler, however, is physically encumbered by his or her baggage. Similarly, a traveler attending a conference or meeting at a convention center often desires to depart directly from the convention center for the airport from which they will board their departing flight. If the conference or meeting ends several hours before their scheduled flight, the traveler may wish to spend a few hours sight-seeing or doing some other activity in the city they are visiting. Once again, however, the traveler's baggage imposes physical constraints on the traveler's freedom and mobility.

In addition to having to transport their baggage to an airport of interest, travelers are further inconvenienced by the process of checking in for their flight at the departure airport. The process of checking in at a ticket counter all too often requires several hours. Airline passengers must endure many inconveniences during the process, including long lines due to overcrowded conditions, personnel shortages, and the congestion and confusion that occur at peak travel times. A need therefore exists for a system of processing passengers and their baggage and issuing boarding passes beginning at a site such as a hotel or convention center that liberates the traveler from the physical constraints imposed by their baggage and the numerous inconveniences experienced during the process of checking in for a flight.

### SUMMARY

The invention relates to a system and method for processing passengers and their baggage and issuing boarding passes. To process a passenger traveling from a hotel to a destination via a commercial flight and his or her baggage, the passenger brings his or her baggage to a passenger/baggage processing kiosk located in the hotel. The kiosk of the invention enables the passenger to check-in for a particular flight and to receive a boarding pass. The kiosk can additionally be used by the passenger to book a flight, change a reservation, as well as perform other functions traditionally performed at an airline ticket counter. The passenger/baggage processing kiosk also provides baggage scales and sizers for weighing baggage and determining if the baggage exceeds an established weight limit. The passenger/baggage processing kiosk also provides the passenger access to a passenger and baggage processing computer system that interfaces with the network(s) of one or more airlines. After the passenger enters the appropriate identification information into the kiosk, the kiosk prints one or more baggage identification tags, a baggage claim receipt, and one or more boarding passes. An authorized agent confirms the identity of the passenger, attaches the baggage identification tag(s) to the baggage, and collects the tagged baggage for transport to a screening facility where the baggage is screened.

A method of the invention for processing passengers and baggage located at a hotel includes providing a passenger in a hotel having baggage; interfacing of the passenger with a passenger/baggage processing kiosk located at the hotel; inputting of information by the passenger into the passenger/baggage processing kiosk; weighing of the baggage; printing at least one baggage identification tag, a baggage claim receipt, and/or at least one boarding pass by the kiosk; collecting the baggage by an authorized agent; securely transporting the baggage to a baggage screening facility; screening the baggage for nonpermissible contents; and transporting the screened baggage to a location designated by the airline (e.g., airplane, airport baggage sorting/handling system).

To process the baggage of a passenger traveling from a convention center to a destination via a commercial flight, the system includes obtaining appropriate passenger information for checking-in to a flight at the time of registering for a conference or event being held at the convention center by one or more organizers of the conference or event; relaying this information to an entity operating the system at the commencement of the conference or event; checking-in the passenger for the flight one or more days ahead of the passenger's departure date by the entity, printing baggage identification tags, boarding passes, and baggage claim receipt and storing of these items until the passenger's departure date; dispensing these items from an authorized agent acting on behalf of the entity, of the airline, or of the convention center, to the passenger on the date of departure; attaching the baggage identification tag(s) to the baggage by the authorized agent, and taking possession of the baggage by the authorized agent; transporting the baggage to a baggage screening facility; screening the baggage; and transporting the baggage from the screening facility to a location designated by the airline (e.g., airplane, airport baggage sorting/handling system).

A method for processing passengers and baggage located at a convention center includes obtaining appropriate passenger information for checking-in to a flight at the time of registering for a conference or event being held at the convention center by one or more organizers of the conference or event; relaying this information to an entity operating the system at the commencement of the conference or event; checking the passenger in for the flight prior to (e.g., one or more days ahead of) the passenger's departure date, printing baggage identification tags, boarding passes, and baggage claim receipt and storing of these items until the passenger's departure date; dispensing of the boarding pass(es) and baggage claim receipt from an authorized agent to the passenger on the date of departure, attaching the baggage identification tag(s) to the baggage by the authorized agent, and taking possession of the baggage by the authorized agent; transporting the baggage to a baggage screening facility; screening the baggage; and transporting the baggage from the screening facility to a location designated by the airline (e.g., airplane, airport baggage sorting/handling system).

For those passengers that did not provide check-in information to the one or more organizers of the conference or event prior to the passenger's departure date, a portable wireless processing device can be used to obtain the check-in information from these passengers, issue baggage identification tags, boarding passes, and baggage claim receipt. Once these items are issued, an authorized agent takes possession of the baggage and transports the baggage to a baggage screening facility.

In preferred embodiments, the screening facility is located away from the airport terminals for security reasons. A baggage bomb explosion, for example, would not impact the airport terminals, airplanes, or airport passengers and employees. The screening facility can be located away from the terminals yet on the airport grounds, located away from the airport grounds, or partially on and partially away from the airport grounds. Once the passenger has received his or her boarding pass(es) and baggage claim receipt, and has handed off the baggage to the authorized agent, the passenger is free to proceed to the airport without the physical constraints imposed by the baggage. Once screened and deemed safe, the baggage is then placed transported to a location designated by the airline (e.g., appropriate airplane, airport baggage sorting/handling system). Because the passenger has checked-in for the flight and received a boarding pass, the passenger can proceed directly to the departure gate and does not have to wait in what is typically a long line at the airline ticket counter.

The system and method of the invention eliminate much of the inconvenience and delay associated with airline travel for passengers located at a hotel or who are attending a conference or other event at a convention center and traveling to a destination via a commercial flight.

Accordingly, the invention features a method for processing baggage of at least twenty-five (e.g., at least 25, 50, 75, 100, 150, 200, 300, 400, 500 or more) travelers per day for transport on an airline flight departing from a departure airport. The method includes the steps of: (a) collecting baggage from the travelers at a hotel or convention center; and (b) marking the collected baggage with identifiers (e.g., a barcode or RFID) at the hotel or convention center, the identifiers including traveler identifying information and airline flight identifying information. This method can further include the step of generating baggage identification tags recognizable by an airline and/or the step of issuing a baggage claim receipt to the traveler. In this method, the departure airport can be located at a distance in the range of about 0.5 km to about 100 km from the hotel or convention center.

In another aspect, the invention features a method for processing at least one (e.g., at least 25, 50, 75, 100, 150, 200, 300, 400, 500 or more) traveler per day for travel on an airline flight. This method includes the step of: issuing a boarding pass to the traveler at a hotel or convention center, the traveler having previously purchased a ticket for the flight. This method can also include the step of subjecting the at least one traveler to security screening (e.g., submitting the passenger's name to the Computer Assisted Passenger Profiling System).

Also within the invention is a method for processing at least one traveler and the traveler's baggage for travel on an airline flight departing from a departure airport. This method includes the steps of: at a hotel or convention center, (a) collecting baggage from the traveler and marking the collected baggage with an identifier includes traveler identifying information and airline identifying information; and (b) issuing a boarding pass to the traveler, the traveler having previously purchased a ticket for the flight. This method can include processing a plurality of passengers (e.g., at least 25, 50, 75, 100, 150, 200, 300, 400, 500 or more) per day. In this method, the at least one traveler can be one that has stayed at least one night at the hotel and/or one attending an event at the conference center. Also in this method, the at least one traveler can arrange for processing at the time the traveler made the hotel reservation, at the time the traveler checks in to the hotel, on the day of checking out of the hotel, at the time the traveler registered for the event, at a time during the event, or on the last day of the event.

In this method, the traveler can use a passenger and baggage processing kiosk located within the hotel or convention center to check in for the airline flight. The kiosk can include a scale, and the method can include weighing the baggage. The method can also include the step of transporting collected baggage to the departure airport, e.g., a screening facility located at the departure airport but at least 0.1 km away from any passenger terminal.

In another aspect, the invention features a system for processing at least one traveler and the traveler's baggage for travel on an airline flight departing from a departure airport. The system includes, at a hotel or convention center: (a) means for collecting baggage from the traveler and marking the collected baggage with an identifier includes traveler identifying information and airline identifying information; and (b) means for issuing a boarding pass to the traveler, the traveler having previously purchased a ticket for the flight. The means for issuing a boarding pass can include a kiosk such as one in communication with at least one airline. The kiosk can include a means for inputting information about the traveler; and a means for printing a boarding pass and a baggage identification tag. The system can also include: a baggage screening facility; a means for transporting baggage from the hotel or convention center to the screening facility; and a means for transporting baggage from the screening facility to an airline.

Although methods and devices similar or equivalent to those described herein can be used in the practice or testing of the present invention, suitable methods and devices are described below. All publications, patent applications, patents, and other references mentioned herein are incorporated by reference in their entirety. In the case of conflict, the present specification, including definitions will control. In addition, the particular embodiments discussed below are illustrative only and not intended to be limiting.

### BRIEF DESCRIPTION OF THE DRAWINGS

FIG. 1 is a diagram illustrating the processing of baggage according to the present invention pertaining to a hotel.

FIG. 2 is a diagram illustrating the processing of baggage according to the present invention pertaining to a convention center.

FIG. 3 is a diagram illustrating transport of the baggage once it has been collected from a passenger.

FIG. 4 is a diagram of a preferred embodiment of the system of the invention pertaining to a hotel.

FIG. 5 is a diagram of a preferred embodiment of the system of the invention pertaining to a convention center.

FIG. 6 is a flowchart illustrating the steps in a preferred embodiment of the present invention pertaining to a hotel.

FIG. 7 is a flowchart illustrating the steps in a preferred embodiment of the present invention relating to a convention center.

### DETAILED DESCRIPTION

The present invention provides a system and a method for processing passengers and baggage located at a hotel or convention center. The below described preferred embodiments illustrate adaptations of these systems and methods. Nonetheless, from the description of these embodiments, other aspects of the invention can be developed and/or practiced based on the description provided below.

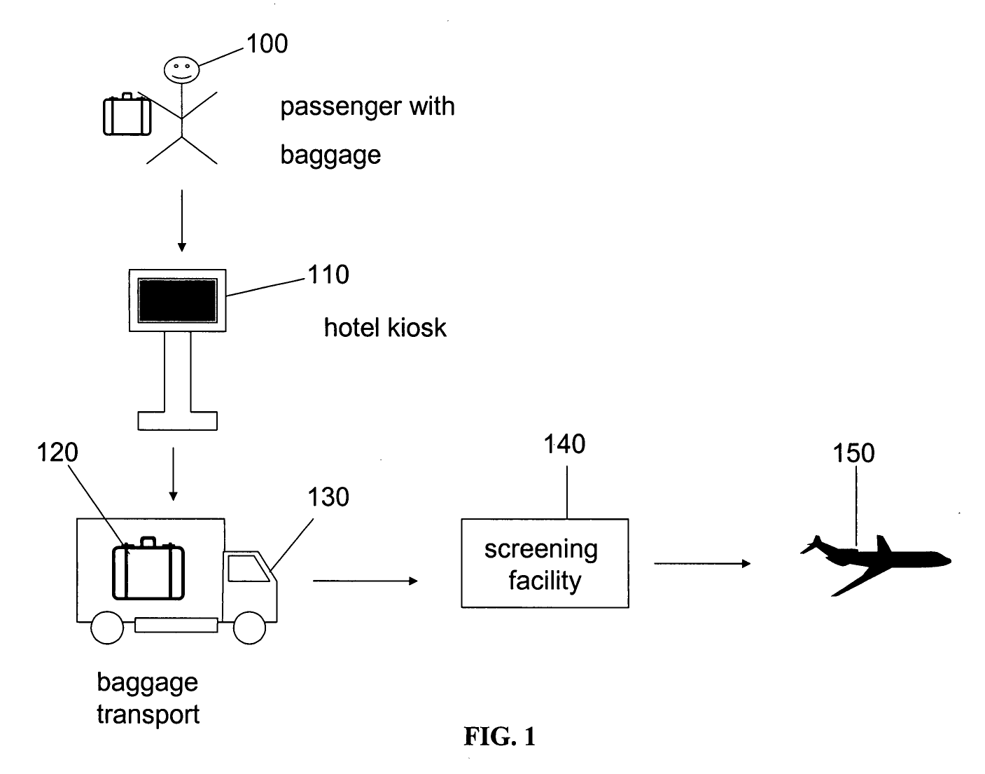

Referring to FIG. 1, a passenger 100 having baggage 120 who is located at a hotel at least 0.1, 0.5, 1.0, 5.0, 10 km, or more away from the airport and who is scheduled to board a commercial flight to a destination approaches a passenger/baggage processing kiosk 110 within the hotel. By interfacing with the kiosk 110, a passenger is able to access a passenger and baggage processing computer system. The passenger/baggage processing kiosk and computer system provides for the checking-in of the passenger, the weighing of the passenger's baggage, issuing of one or more boarding passes, one or more baggage identification tags, a baggage claim receipt, as well as a number of other functions traditionally performed at an airline ticket counter (e.g., booking a flight, changing a reservation). One or more authorized agents are stationed at or near the passenger/baggage processing kiosk 110. Using the kiosk 110, the passenger 100 is able to access the network (i.e., computer system) of the airline providing the flight. By inputting the appropriate identification information (e.g., name, driver's license number, credit card number, airline flight number, number of pieces of baggage), via a credit card or driver's license into the kiosk, for example, or typing information using a keyboard, the passenger 100 is able to check-in for the scheduled flight. The kiosk also features baggage scales and sizers for weighing the baggage and determining if the baggage exceeds an established size and weight limit.

The kiosk 110 prints a boarding pass for the passenger as well as a baggage identification tag for each piece of baggage 120. One baggage identification tag is attached to each piece of baggage 120. The baggage identification tag is preferably marked with a barcode or like identification device, the data from the barcode matching an entry in a database within the airline network (e.g., computer system) or baggage processing server described below. The authorized agent preferably has a hand-held or portable identifying device (e.g., barcode scanning device) in communication with the database that is able to read the barcode or like identification device. Using the hand-held or portable identifying device (e.g., barcode scanning device), the authorized agent is able to generate a log of all baggage 120 that is taken into possession by the authorized agent. Alternatively, the authorized agent can generate a log of all baggage by non-electronic means. Each piece of baggage 120 may also be marked with a radio frequency identification (RFID) tag to further facilitate tracking of the piece of baggage 120. In this embodiment, the authorized agent has a hand-held or portable identifying device able to communicate with the RFID. Typically, a baggage claim receipt is issued by the kiosk 110 to evidence receipt of the passenger's baggage 120. In the event the baggage 120 is misplaced or lost, the passenger's claim ticket can be used to facilitate reclaiming of the baggage 120 or for filing a claim of lost baggage.

In another embodiment of the invention, the system and method are useful for processing a passenger and his or her baggage who is attending or is scheduled to attend a conference or other event at a convention center. The processing of a passenger who is scheduled to attend a conference or other event at a convention center and his or her baggage can begin when the passenger is registering for the conference or event. In this method, an organizer of the conference or event obtains check-in information from the passenger at the time the passenger is registering for the event. Check-in information includes the passenger's name, address, country of citizenship, the airline offering the flight, and destination.

At the time of the commencement of the conference or other event, the passenger's check-in information is relayed to the entity operating the system of the invention. Subsequent to the conference or event commencement date but prior to the passenger's departure date, the passenger is checked in for his or her flight by an authorized agent acting on behalf of the entity, on behalf of the airline, or on behalf of the convention center. At this time, the following items are printed and stored: one baggage identification tag for each piece of baggage, one or more boarding passes, and a baggage claim receipt. These items are securely stored until the passenger's departure date.

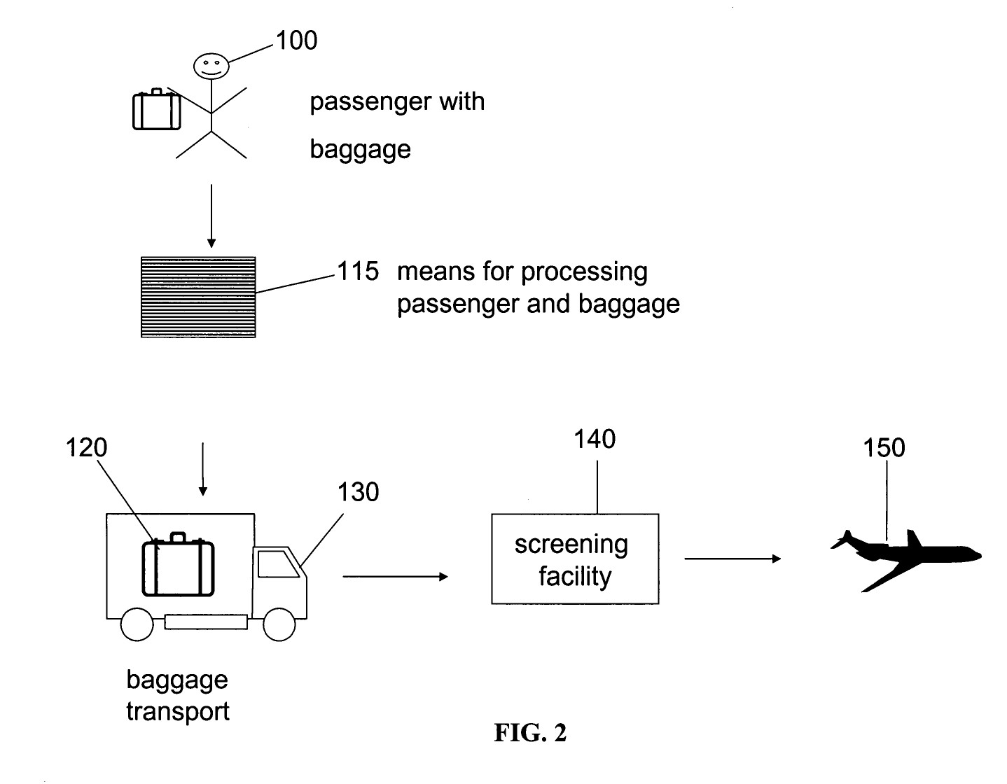

Referring to FIG. 2, a passenger 100 having baggage 120 who is located at the convention center at least 0.1, 0.5, 1.0, 5.0, 10 km, or more away from the airport and who is scheduled to board a commercial flight to a destination interfaces with a means 115 for processing the passenger and his or her baggage. The means for processing the passenger and his or her baggage includes an authorized agent and a passenger and baggage processing computer system. At an appropriate time on the day of departure an authorized agent acting on behalf of the entity operating the system of the invention, on behalf of the airline or the convention center, dispenses the baggage claim receipt and one or more boarding passes to the passenger and attaches the baggage identification tag(s) to the baggage. As described for FIG. 1, the baggage identification tag is preferably marked with a barcode or like identification device, the data from the barcode matching an entry in a database within the airline computer system or passenger and baggage processing server described below. The authorized agent (i.e., authorized agent) preferably has a hand-held or portable identifying device (e.g., barcode scanning device) in communication with the database that is able to read the barcode or like identification device.

Using the hand-held or portable identifying device (e.g., barcode scanning device), the authorized agent is able to generate a log of all baggage 120 that is taken into possession by the authorized agent. The authorized agent then takes possession of the baggage 120 and transfers the baggage 120 (e.g., via a transport vehicle 130) to a baggage screening facility 140 as described below. In some embodiments, the authorized agent generates and maintains a log of baggage using non-electronic means.

For those passengers that did not provide check-in information to the conference organizer(s) prior to their date of departure, the means 115 for processing the passenger 100 and his or her baggage 120 involves an authorized agent using a portable wireless processing device to obtain the check-in information of the passenger 100. After obtaining the information, the authorized agent dispenses to the passenger 100 a baggage claim receipt and one or more boarding passes and attaches a baggage identification tag to each piece of baggage 120. At this time, the authorized agent typically confirms that the identity (e.g., driver's license, passport, etc.) of the passenger matches the identity on the boarding pass. The authorized agent can confirm the identity of the passenger 100 using any suitable means (e.g., biometric identification). The authorized agent can additionally screen the passenger 100 with security questions and report the screening results to the airline or appropriate security agency. The authorized agent then takes possession of the baggage 120 and transports the baggage 120 (e.g., via a transport vehicle 130) to a baggage screening facility 140 as described below. In some embodiments, the system of the invention can include use of the portable wireless processing device in conjunction with a stationary passenger/baggage processing kiosk as described above in the hotel embodiments to increase passenger/baggage processing efficiency.

In the hotel and convention center embodiments of the invention, upon taking possession of the baggage 120, the authorized agent transports the baggage 120 out of the hotel or convention center to a waiting transport vehicle 130 which transports the baggage 120 to the screening facility 140. Alternatively, the authorized agent can wait for a second authorized agent to enter the hotel or convention center, take possession of the baggage 120, and transport the baggage 120 to a transport vehicle 130. In a preferred embodiment, the authorized agent securely stores the baggage 120 (e.g., in a nearby secured area) while additional passengers' baggage 120 is being processed. This embodiment is preferred because the bulk processing of passengers and baggage is more economical and efficient than the processing of individuals. After several passengers 100 have had their baggage 120 processed, the authorized agent can then transport the several passengers' baggage 120 out of the hotel or convention center and into a transport vehicle 130. Alternatively, a second authorized agent can enter the hotel or convention center, take possession of the several passenger's baggage 120, and transport the baggage 120 to a transport vehicle 130.

The authorized agent(s) may be an agent acting on behalf of the airline, or an agent acting on behalf of an entity that operates the passenger and baggage processing system of the invention. The authorized agent(s) may also act on behalf of the entity that operates the hotel or convention center, or on behalf of the entity that organizes the conference or event at the convention center. The authorized agent transports the baggage to the screening facility 140 via any suitable vehicle 130, preferably a van or a truck. In preferred embodiments, the vehicle 130 is equipped with a global positioning system (GPS) tracking device by which an outside party (i.e., law enforcement agency, airline, entity that operates the hotel or convention center, entity that operates the passenger and baggage processing system of the invention) can track the location of and route taken by the vehicle 130. If the vehicle deviates from its course to the airport, the appropriate outside party can turn-off or disable the vehicle using a remote device in communication with the tracking device.

The baggage 120 is transported by an authorized agent to a secure screening facility 140 of the invention. The screening facility 140 and its procedures comply with all standard requirements and regulations. In the United States, for example, the screening facility 140 and its procedures comply with all airport, state Department of Transportation (DOT), Transportation Security Administration (TSA), and airport carrier security programs and regulations. At the screening facility 140, the incoming baggage 120 can be sorted according to a number of parameters, including airline and flight departure time. Baggage 120 can be placed into a priority queue for screening based on a number of different parameters, including flight departure times, such that the baggage 120 that has the earliest departure time is screened first. The baggage 120 is screened by appropriate authorized personnel, such as personnel approved and/or employed by the TSA. Once screened, the baggage 120 is securely stored until flight time approaches and then transported to the appropriate airplane. The screened baggage 120 can be transported directly from the screening facility 140 to a location designated by the airline (e.g., the appropriate airplane 150, the airport's baggage sortation/handling system).

In a preferred embodiment, the screening facility is located away from the passenger terminals. By locating the screening facility away from the passenger terminals, the security of the screening process is enhanced by moving the screening process away from the noise and confusion often present at passenger terminals. The safety of people within the airport is increased by locating the screening facility away from the passenger terminals because, for example, any bomb explosion that occurs at the screening facility would impact people at the airport less than an explosion that occurs at the passenger terminals. For this reason, in preferred embodiments, the screening facility is located at a distance from the terminals in the range of about 0.1 to about 10.0 km or more (e.g., 0.08, 0.1, 0.5, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 50, 100 km).

The screening facility can be partially located on the airfield and partially located on a site that is accessible to the public. The screening facility can also be entirely located on the airfield or on a site that is not accessible to the public. In another embodiment, the screening facility is located at a site that is not on airport grounds. By locating the screening facility off-site from the airport, the high costs associated with airport space can be decreased. In some embodiments, however, it may be desirable to locate the screening facility within or near the passenger terminals.

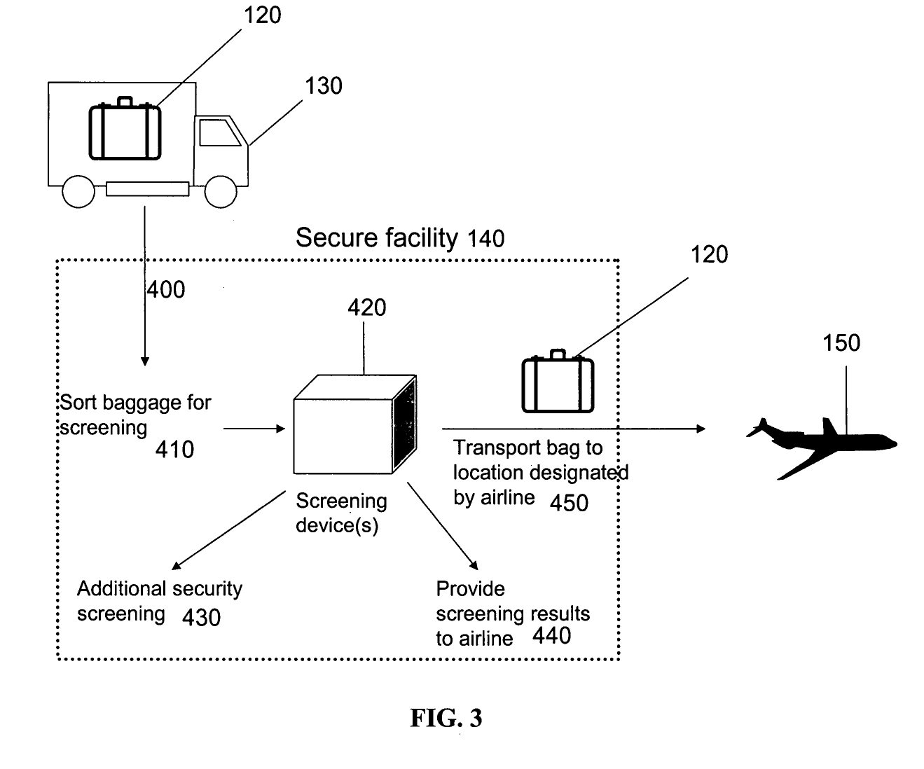

As shown in FIG. 3, in step 400, baggage 120 is delivered by at least one authorized agent to the secure screening facility 140. In step 410, received baggage 120 is prioritized and sorted based on the time remaining until the respective flights are scheduled to depart. The baggage 120 may additionally be sorted based on factors such as destination location, bag size, or other factors germane to screening and security. Prior to and after screening, the baggage 120 is held in a secure environment. Within the system of the invention is a means for recording each person who handles a particular piece of baggage 120.

In step 420, the sorted baggage 120 is processed by one or more screening devices or systems. One such device is an explosive detection system (EDS) machine. The screening facility 140 may have one or several EDS machines. If the screening facility 140 has more than one EDS machine, the baggage 120 can be processed in parallel to increase the efficiency of the screening process. Another appropriate screening device is an X-ray system for detecting metal objects such as knives, guns or other illegal contraband, including illegal drugs. Another screening device useful in the invention is an Electronic Trace Detection System (ETD) which scans for traces of chemicals used to build explosive devices. In step 430, baggage 120 that does not clear screening is flagged for additional security screening. If appropriate, law enforcement agents as well as the owner of the baggage 120 are informed. If the baggage 120 clears the screening process, in step 450, baggage 120 is directed to a location designated by the airline (e.g., the airplane 150, the airport's baggage sortation/handling system for subsequent transfer to the appropriate airplane 150). In one variation of the system, the baggage to be screened is placed in an in-line automated system. An in-line automated system allows the baggage to be transported through the screening process described above using a series of conveyors that connect one screening device to another. The use of a conveyor-based system provides for simple reconfiguring or upgrading of the screening facility. If, for example, an additional EDT is to be added to the screening facility, the additional EDT is simply placed amongst existing screening devices and connected to the conveyors. In step 440, screening results are reported to the appropriate airline.

Several benefits are conferred by the passenger and baggage processing system and method of the invention. First, the system and method of the invention eliminate much of the inconvenience and delay associated with airline travel. Not only is the passenger spared from transporting heavy and cumbersome baggage to the airport, but also from waiting in what is typically a long line at the airline ticket counter. Second, the issuance of a boarding pass to the passenger well in advance of the flight and off-site from the passenger terminals decreases congestion at the airport. Third, use of the system and method increases security, as baggage screening is performed in a secure facility less accessible to the public and away from the passenger terminals.

For increasing security, the invention includes a means for tracking the location and integrity of each piece of baggage from the time it is collected from the passenger to the time it is transported to a location designated by the airline (e.g., airplane, airport baggage sorting/handling system). The means can include a baggage database storing information on each piece of baggage in communication with a GPS that enables tracking of ground and/or air transportation vehicles transporting the baggage via terrestrial and satellite networks. The baggage database may also be in communication with the computer systems of airlines, departure control systems, and security agencies. Preferably, information such as itinerary changes (e.g., flight delays, cancellations) can be transmitted from airline computer systems to the baggage database. By updating the baggage database with such information, baggage can be routed properly with minimum delay.

As described above, a passenger's baggage is collected from the passenger at a hotel or convention center, transported to a screening facility, screened, and to a location designated by the airline (e.g., airplane, airport baggage sorting/handling system). The passenger, therefore, does not transport his or her baggage from the hotel or convention center to the airport or wait in line at the ticket counter to check-in and receive a boarding pass. Thus, upon arriving at the airport, the passenger can proceed directly to the departure gate. The passenger and baggage are loaded onto the appropriate airplane and flown to the passenger's destination airport. At the destination airport, the passenger can retrieve his or her baggage from the baggage claim carousel. In other embodiments, the passenger and baggage processing system and method of the invention include an additional step of transporting the baggage from the destination airport to the passenger's home, or other final destination. In this embodiment, the passenger is free to leave the airport after landing and proceed home, for example. The passenger is spared from retrieving baggage from the carousel and transporting the baggage home or to another final destination (e.g., hotel, office) because the baggage is delivered directly to a location designated by the passenger.

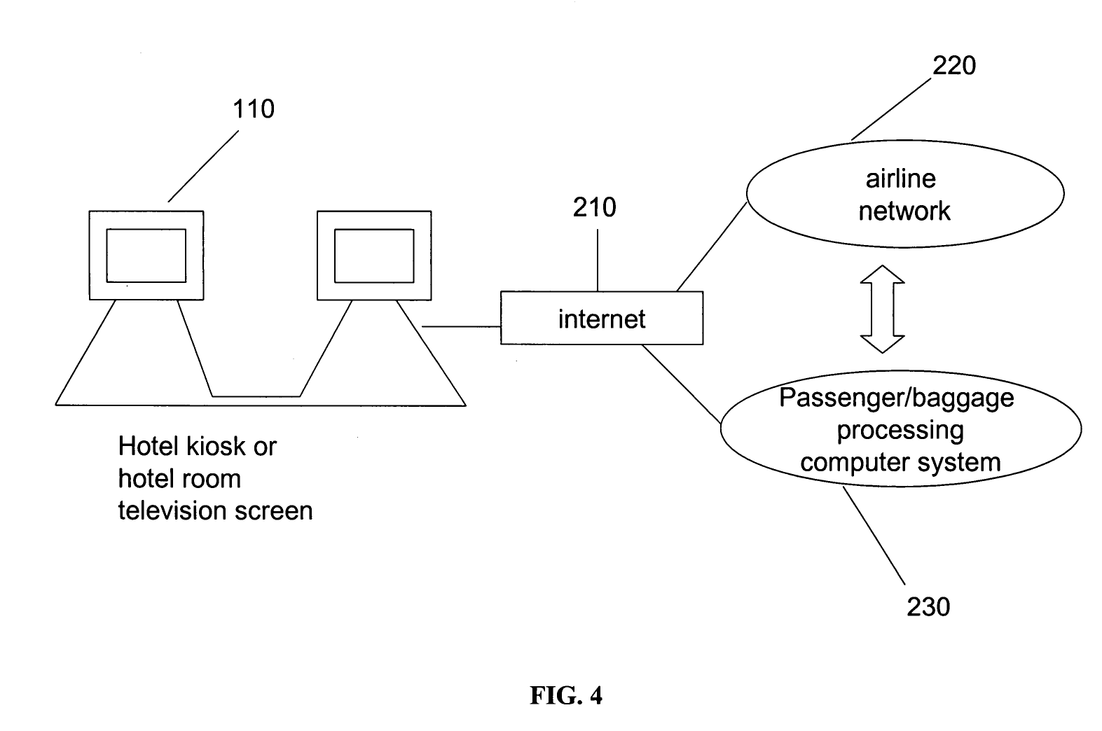

Referring now to FIG. 4, a user of the system (e.g., passenger) located at a hotel accesses a passenger and baggage processing computer system that is accessible through a passenger/baggage processing kiosk 110 located within in the hotel. In some embodiments, the passenger and baggage processing computer system 230 can be maintained by a server computer having a baggage database. A baggage database of the invention can store baggage identification information in linked relation to a final delivery location (e.g., airport) specified by the user (e.g., passenger). Through the passenger and baggage processing computer system, the user is linked to the networks (e.g., computer systems 220) of participating airlines. The passenger and baggage processing computer system is linked to the networks of participating airlines via a communications network (e.g., the internet 210). By accessing the passenger and baggage computer system, the user is able to check-in for a reserved flight and receive a boarding pass, a baggage identification tag, and a baggage claim receipt. The kiosk can also be used by a passenger to book a flight or change a reservation. Typically, while the passenger is purchasing airline tickets, the passenger is presented with the option of arranging for the processing of his or her baggage according to the invention. It is also possible, however, that the passenger can arrange for processing of his or her baggage at a time subsequent to purchasing their tickets (e.g., one or more days later, on the day of their flight). The passenger, for example, can arrange for the processing of his or her baggage on the day of their departing flight.

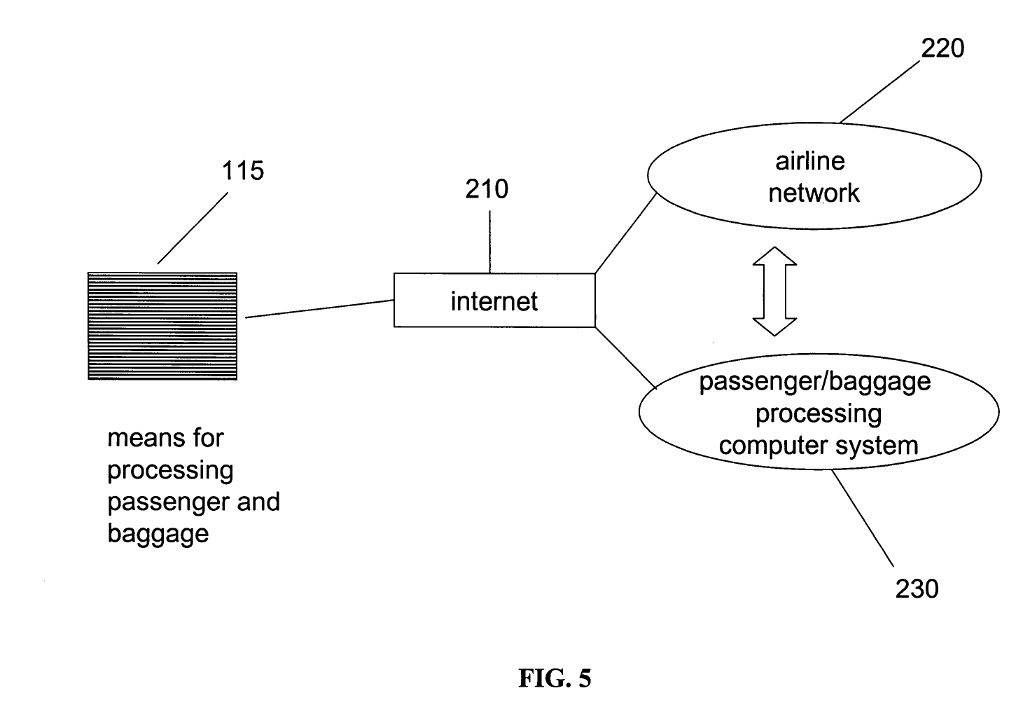

Referring now to FIG. 5, a user of the system (e.g., passenger) and his or her baggage is processed by a means 115 for processing passenger and baggage. The means 115 typically involves a conference or event organizer and an authorized agent in communication with the passenger and linked to the passenger and baggage processing computer system 230 and to the networks 220 of participating airlines. The means 115 for processing baggage, airline networks 220 and baggage processing computer system 230 are all linked via a communications network such as the internet 210. The passenger and baggage processing computer system can be maintained by a passenger and baggage server computer having a baggage database as described above. By accessing the passenger and baggage computer system, the user is able to check-in for a reserved flight, and receive a boarding pass(es), a baggage identification tag(s), and a baggage claim receipt. The passenger and baggage computer system can also be used by a user to book a flight or change a reservation.

If payment is required for use of the system of the invention, payment can be made by the passenger using the passenger/baggage kiosk. In this embodiment, a passenger can insert a credit card or debit card into the kiosk and authorize payment. In another embodiment, payment can be made by a means other than a kiosk. For example, a passenger can make payment using an automated ticket dispenser machine located in a location such as a hotel or casino. As with the kiosk, the passenger can insert a credit card or debit card into the ticket dispenser machine to make a payment

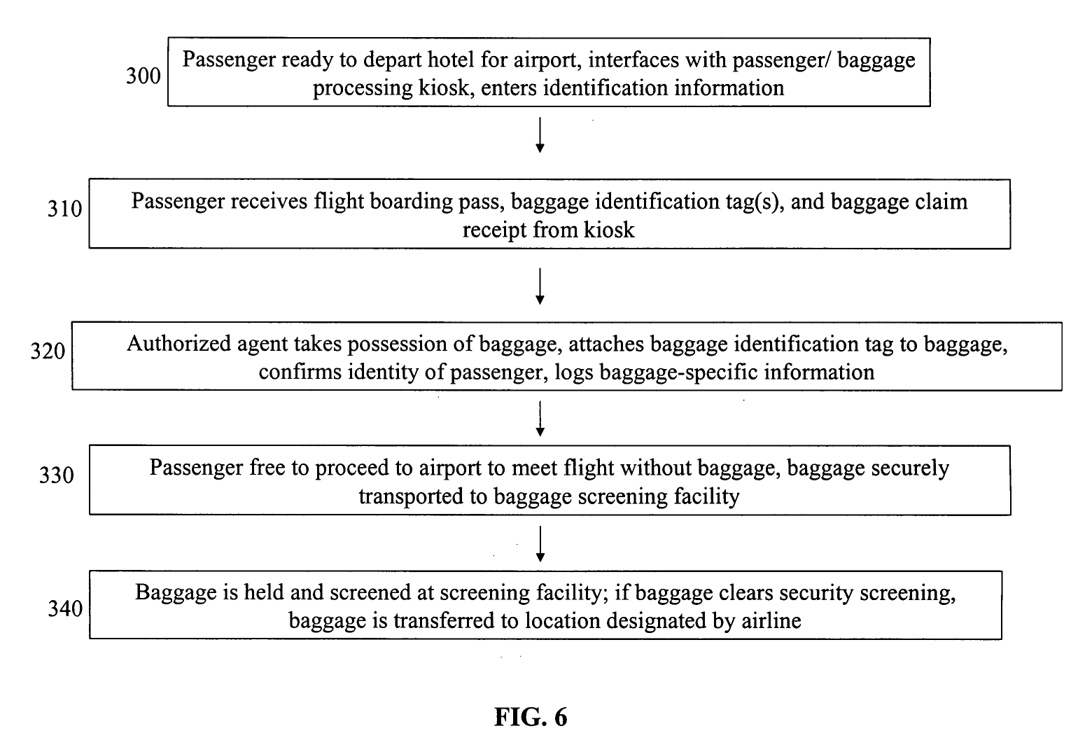

Typical operation of the system and method of the invention pertaining to a passenger staying at a hotel is further described in FIG. 6. In step 300 of FIG. 6, a passenger ready to depart a hotel who is scheduled for a flight from a particular airport interfaces with a passenger/baggage processing kiosk located in the hotel and inputs information such as identification information (e.g., name, driver's license number, credit card number, airline, flight number, number of pieces of baggage). Information can be inputted by the passenger using a keyboard or a touch-key screen. Alternatively or additionally, information can be inputted via the insertion of an identification card (e.g., driver's license) or a credit card. In step 310, the passenger receives a boarding pass, a baggage identification tag to be attached to the baggage, and a baggage claim receipt. In step 320, an authorized agent who is stationed at or near the kiosk then takes possession of the baggage and attaches the kiosk-issued baggage identification tags to each piece of baggage. The authorized agent then typically enters information pertaining to the baggage into a baggage log. In some embodiments, this involves obtaining information from the baggage identification tag(s) (e.g., scanning a bar code) and entering the information into a baggage database. The authorized agent preferably confirms that the identity of the passenger matches the identity on the boarding pass(es). As shown in step 330 once the authorized agent takes possession of the baggage and the passenger clears the identification confirmation, the passenger is then free to proceed to the airport and the baggage is transported to the baggage screening facility.

The authorized agent can either transport the baggage out of the hotel to a waiting transport vehicle which will transport the baggage to the screening facility, or the authorized agent can wait for a second authorized agent to enter the hotel, take possession of the baggage, and transport the baggage to a transport vehicle. In a preferred embodiment, the authorized agent can securely store the baggage (e.g., in a nearby secured area) while additional passengers' baggage is being processed. After several passengers have had their baggage processed, the authorized agent can then transport the baggage out of the hotel and into a vehicle. Alternatively, a second authorized agent can enter the hotel, take possession of the baggage, and transport the baggage to a transport vehicle.

In step 340, the baggage is held and screened at the baggage screening facility as described above. After the baggage is processed by one or more screening devices or systems and is deemed safe, the screened baggage is transported to a location designated by the airline (e.g., the appropriate airplane, airport baggage sorting/handling system). Preferably, the screened baggage that is loaded onto the airplane is matched with the passenger upon boarding to ensure that the passenger and his or her baggage are on the same flight. If the authorized agent is delayed in transporting baggage to the screening facility and the baggage is not loaded onto the appropriate flight before the flight departs, or if the flight is missed due to delays in the screening process, arrangements are made for the baggage to be loaded onto another flight. Passenger claims for missing or damaged baggage can be made to and handled by the entity operating the passenger and baggage processing system, by an authorized agent, or in some cases, by the appropriate airline. In the event there are any problems associated with the transport of the baggage (e.g., the baggage is not loaded onto the scheduled flight, the baggage is lost or damaged), attempts are made to notify the passenger as quickly as possible (e.g., by telephone, email).

In an alternative embodiment of the invention, a passenger can use the passenger and baggage processing system of the invention via a means other than a kiosk in the hotel. An alternative means, for example, is the use of hotel room interactive television. Before checking out of one's hotel room, the passenger can interface with the passenger and baggage processing computer system by turning on the television and navigating to the passenger and baggage processing computer system. The passenger can navigate to the system using a remote control, keyboard, or touch-key screen. Once within the computer system, the passenger can check-in for his or her flight and receive a boarding pass, baggage identification tag, and baggage claim receipt. These items can be printed by a printer in communication with the television in the hotel room, or can be printed by a printer outside of the hotel room, such as a printer at the hotel registration desk, for example. Once the passenger has received these items, the passenger can proceed to a baggage processing kiosk, desk, or station, preferably located in the hotel lobby or other location on the hotel premises. One or more authorized agents are stationed at the kiosk, desk, or station and proceed to collect the passenger's baggage and confirm the identification of the passenger before transporting the baggage to the airport. Other means include a personal computer (e.g., laptop computer) and a telephone.

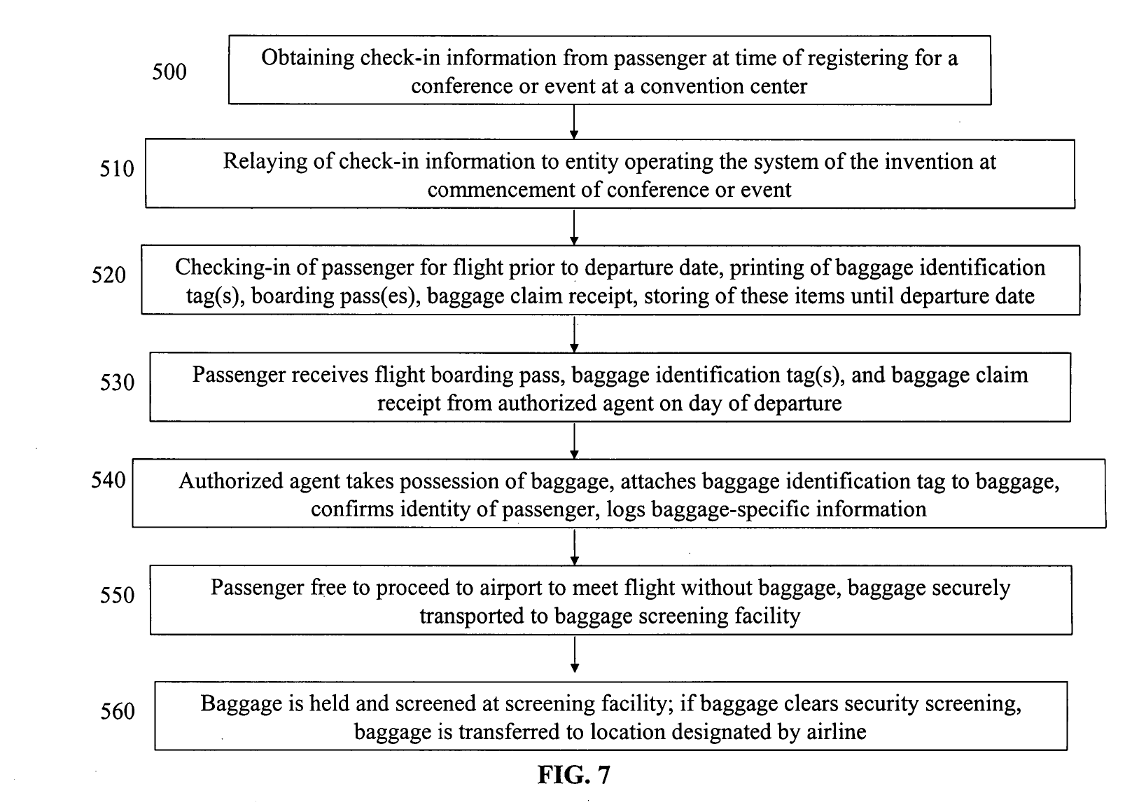

Typical operation of the system and method of the invention pertaining to a passenger at a conference or other event at a convention center is further described in FIG. 7. In step 500 of FIG. 7, an organizer of the conference or event obtains check-in information (e.g., name, address, airline, number of pieces of baggage) from the passenger at the time the passenger registers for the conference or event. In step 510, at the commencement of the conference or event, the passenger's check-in information is relayed from the organizer of the conference or event to the entity operating the system of the invention. In step 520, the passenger is checked-in by an authorized agent acting on behalf of the entity operating the system of the invention on a date that is subsequent to the commencement of the conference or event but prior to the passenger's departure date. At this time, one or more boarding passes, baggage identification tags, and a baggage claim receipt are printed by the authorized agent. These items are securely stored until the date of the passenger's departure. On the date of departure, in step 530, the passenger receives a boarding pass and a baggage claim receipt from an authorized agent acting on behalf of the entity operating the system of the invention. In step 540, the authorized agent (e.g., authorized agent) then takes possession of the baggage and attaches baggage identification tags to each piece of baggage. The authorized agent then obtains information from the baggage identification tag(s) and enters the information into a baggage log or into an electronic baggage database. The authorized agent preferably confirms that the identity of the passenger matches the identity on the boarding pass(es).

As shown in step 550 once the authorized agent takes possession of the baggage and the passenger clears the identification confirmation, the passenger is then free to proceed to the airport and the baggage is transported to the baggage screening facility. The authorized agent can then transport the baggage to the screening facility as described above for FIG. 6. In step 560, the baggage is held and screened at the baggage screening facility as described above.

As noted above, in some embodiments, a passenger can monitor the status of his or her baggage transport at any time during the passenger and baggage processing by using a computer or wireless communication device (e.g., PDA, cellular telephone, Blackberry™ device). To obtain the status of one's baggage, the passenger accesses the passenger and baggage processing computer system and enters appropriate identification information (e.g., social security number, passcode, flight confirmation number, baggage claim receipt information) into the computer system. After the passenger's identification is confirmed (e.g., via entry of any of the identification information above), the status of the baggage of interest is provided to the passenger. The status may be provided by an automated system, by a human being, or by text.

In some embodiments of the invention, entities such as rental car companies, travel agents, and other service providers can be enabled to communicate with the passenger/baggage computer system to allow such entities to provide baggage-related services to passengers.

The invention also includes a system and method for processing cargo. In a typical embodiment, cargo is brought to the screening facility by, for example, a commercial vendor or private individual. The cargo is screened according to the method described above for screening baggage. An in-line automated system configured to screen commercial cargo and additional bays that can receive often large-sized commercial cargo can be added to the screening facility described above.

While the above specification contains many specifics, these should not be construed as limitations on the scope of the invention, but rather as examples of preferred embodiments thereof. Many other variations are possible. Accordingly, the scope of the invention should be determined not by the embodiments illustrated, but by the appended claims and their legal equivalents.

1. A method for processing baggage of at least twenty-five travelers per day for transport on an airline flight departing from a departure airport, the method comprising the steps of:
(a) collecting baggage from the travelers at a hotel or convention center; and
(b) marking the collected baggage with identifiers at the hotel or convention center, the identifiers comprising traveler identifying information and airline flight identifying information.

2. The method of claim 1, wherein the identifier comprises a barcode.

3. The method of claim 1, wherein the identifier comprises an RFID device.

4. The method of claim 1, further comprising the step of generating baggage identification tags recognizable by an airline.

5. The method of claim 1, further comprising the step of issuing a baggage claim receipt to the traveler.

6. The method of claim 1, wherein the at least twenty-five travelers comprises at least one hundred travelers.

7. The method of claim 1, wherein the at least twenty-five travelers comprises at least two hundred travelers.

8. The method of claim 1, wherein the at least twenty-five travelers comprises at least five hundred travelers.

9. The method of claim 1, wherein the departure airport is located at a distance in the range of about 0.5 km to about 100 km from the hotel or convention center.

10. A method for processing at least one traveler per day for travel on an airline flight, the method comprising the step of: issuing a boarding pass to the traveler at a hotel or convention center, the traveler having previously purchased a ticket for the flight.

11. The method of claim 10, further comprising the step of subjecting the at least one traveler to security screening.

12. The method of claim 11, wherein the step of subjecting the at least one traveler to security screening comprises submitting the traveler's name to the Computer Assisted Passenger Profiling System.

13. The method of claim 10, wherein the at least one traveler comprises at least twenty-five travelers

14. A method for processing at least one traveler and the traveler's baggage for travel on an airline flight departing from a departure airport, the method comprising the steps of:
at a hotel or convention center,
(a) collecting baggage from the traveler and marking the collected baggage with an identifier comprising traveler identifying information and airline identifying information; and
(b) issuing a boarding pass to the traveler, the traveler having previously purchased a ticket for the flight.

15. The method of claim 14, wherein a plurality of travelers are processed per day.

16. The method of claim 15, wherein the plurality of travelers comprises at least 25 travelers.

17. The method of claim 15, wherein the plurality of travelers comprises at least 100 travelers.

18. The method of claim 15, wherein the plurality of travelers comprises at least 200 travelers.

19. The method of claim 14, wherein the at least one traveler stays at least one night at the hotel.

20. The method of claim 19, wherein the at least one traveler arranges for processing at a time selected from the group consisting of: at the time the traveler made the hotel reservation, at the time the traveler checks in to the hotel, and on the day of checking out of the hotel.

21. The method of claim 14, wherein the traveler is attending an event at the conference center.

22. The method of claim 21, wherein the traveler arranges for processing at a time selected from the group consisting of: at the time the traveler registered for the event, at a time during the event, and on the last day of the event.

23. The method of claim 14, wherein the traveler uses a passenger and baggage processing kiosk located within the hotel or convention center to check in for the airline flight.

24. The method of claim 23, wherein the passenger and baggage processing kiosk comprises a scale.

25. The method of claim 24, wherein the traveler's baggage is weighed using the passenger and baggage processing kiosk.

26. The method of claim 14, further comprising the step of transporting collected baggage to the departure airport.

27. The method of claim 14, further comprising the step of transporting collected baggage to a screening facility located at the departure airport but at least 0.1 km away from any passenger terminal.

28. The method of claim 14, further comprising the step of transporting collected baggage to a screening facility located at a site away from the departure airport.

29. A system for processing at least one traveler and the traveler's baggage for travel on an airline flight departing from a departure airport, the system comprising:
at a hotel or convention center,
(a) means for collecting baggage from the traveler and marking the collected baggage with an identifier comprising traveler identifying information and airline identifying information; and
(b) means for issuing a boarding pass to the traveler, the traveler having previously purchased a ticket for the flight.

30. The system of claim 29, wherein the means for issuing a boarding pass comprises a kiosk.

31. The system of claim 30, wherein the kiosk is in communication with at least one airline and comprises:
a means for inputting information about the traveler; and
a means for printing a boarding pass and a baggage identification tag.

32. The system of claim 29, wherein the system further comprises:
a baggage screening facility;
a means for transporting baggage from the hotel or convention center to the screening facility; and
a means for transporting baggage from the screening facility to an airline.
